(19) United States
(12) Patent Application Publication
(10) Pub. No.: US 2021/0160451 A1
(43) Pub. Date: May 27, 2021

(54) DISPLAY DEVICE

(71) Applicant: SAMSUNG ELECTRONICS CO., LTD., Suwon-si, Gyeonggi-do (KR)

(72) Inventors: Dae Sik YOON, Suwon-si (KR); Sung Soo JUNG, Suwon-si (KR); Dae Su CHOI, Suwon-si (KR); Hyun Yong CHOI, Suwon-si (KR); Hyun Jun JUNG, Yongin-si (KR)

(73) Assignee: SAMSUNG ELECTRONICS CO., LTD., Suwon-si, Gyeonggi-do (KR)

(21) Appl. No.: 17/256,360

(22) PCT Filed: Sep. 13, 2018
(86) PCT No.: PCT/KR2018/010791

§ 371 Date: Dec. 28, 2020

(30) Foreign Application Priority Data
Jul. 4, 2018 (KR) 10-2018-0077574

(51) Int. Cl. H04N 5/655; G06F 1/16

(52) U.S. Cl. CPC H04N 5/655; G06F 1/1607

(57) ABSTRACT

The present disclosure relates to a display apparatus including a display on which an image is displayed, and a rotating device to rotate the display, wherein the rotating device includes a fixed bracket, a rotating bracket to rotate relative to the fixed bracket and rotate the display, a torsion spring disposed between the fixed bracket and the rotating bracket to apply a rotational force in a second direction opposite to the first direction when the display rotates in a first direction, and a friction member to generate rotational friction when the rotating bracket rotates.

### TECHNICAL FIELD

The present disclosure relates to a display apparatus, and more particularly, to a display apparatus provided with a rotating device.

### BACKGROUND ART

A display apparatus is a device that displays an image, such as a television or a monitor. A display apparatus may include a self-light emitting display panel such as an organic light emitting diode (OLED) or a light-receiving/emitting display panel such as a liquid crystal display (LCD).

A display apparatus may include a display assembly to display an image, a stand to support the display assembly, and the like. Because the display assembly is substantially formed in a plate shape, the stand and the like are required to stand or support the display assembly.

However, because heights of users who use a display apparatus or use environments are different and the users have different methods and purposes of using the display apparatus, there is a need for a configuration capable of supporting the display assembly while varying the arrangement and height of the display assembly.

### DISCLOSURE

### Technical Problem

The present disclosure is directed to providing a display apparatus to which a rotating device capable of facilitating rotation is applied.

The present disclosure is directed to providing a display apparatus to which a rotating device capable of smoothing rotation through a rotational friction force and a rotational force of a torsion spring is applied.

The present disclosure is directed to providing a display apparatus to which a rotating device whose height is adjusted simultaneously with rotation by an eccentric rotation shaft member is applied.

### Technical Solution

One aspect of the present disclosure provides a display apparatus including a display on which an image is displayed, and a rotating device configured to rotate the display, wherein the rotating device includes a fixed bracket, a rotating bracket configured to rotate relative to the fixed bracket and rotate the display, a torsion spring disposed between the fixed bracket and the rotating bracket and configured to apply a rotational force in a second direction opposite to the first direction when the display rotates in a first direction, and a friction member configured to generate rotational friction when the rotating bracket rotates.

The rotational force of the torsion spring may act in the second direction when the display rotates in the second direction.

The rotating bracket may include a rotation shaft member eccentrically disposed at a center of gravity of the display, and the rotation shaft member may be positioned higher or lower than the center of gravity of the display.

The display apparatus may further include a fixing member coupled to the rotation shaft member to adjust rotational friction between the rotating bracket and the fixed bracket.

The display apparatus may further include a support bracket configured to support the fixing member from the rear of the fixed bracket.

The friction member may include a first friction member disposed between the rotation shaft member and the rotating bracket, and a second friction member disposed between the fixed bracket and the fixing member.

The rotating bracket may include a first rotating bracket fixed to the display and a second rotating bracket provided on the first rotating bracket and configured to accommodate the torsion spring, and each of the first rotating bracket and the second rotating bracket may include a torsion spring fixing hole to fix one end of the torsion spring.

The fixed bracket may include a torsion spring fixing portion to fix the other end of the torsion spring.

The display apparatus may further include a stopper to restrict the rotation of the rotating bracket.

The display may be configured to be rotatable in a horizontal mode and a vertical mode, and a center of gravity C1 of the display in the horizontal mode may be positioned higher than a center of gravity C2 of the display in the vertical mode.

A position of the rotation shaft member in the horizontal mode may be the same as a position of the rotation shaft member in the vertical mode.

Another aspect of the present disclosure provides a display apparatus including a display, and a rotating device configured to rotate the display in a first mode and a second mode, wherein the rotating device includes a fixed bracket, a rotating bracket configured to rotate relative to the fixed bracket and rotate about a rotation shaft member eccentrically disposed at a center of gravity of the display, a torsion spring disposed between the fixed bracket and the rotating bracket and configured to apply a rotational force to the rotating bracket, and a friction member configured to generate rotational friction when the rotating bracket rotates.

The display apparatus may further include a fixing member coupled to the rotation shaft member to adjust rotational friction between the rotating bracket and the fixed bracket.

The display apparatus may further include a support bracket configured to support the fixing member from the rear of the fixed bracket.

The friction member may include a first friction member disposed between the rotation shaft member and the rotating bracket, and a second friction member disposed between the fixed bracket and the fixing member.

The display apparatus may further include a stopper to restrict the rotation of the rotating bracket.

Rotational frictional forces of the rotating bracket and the fixed bracket and the rotational force of the torsion spring act in a second direction that is opposite to a first direction CW when the display rotates in the first direction to switch from the first mode to the second mode.

A center of gravity C1 of the display in the first mode may be positioned higher than a center of gravity C2 of the display in the second mode.

### Advantageous Effects

According to an embodiment of the present disclosure, a rotating device of a display apparatus acts as a damper to reduce an impact applied to a product during rotation, thereby inducing a smooth rotation.

Further, because a rotation shaft member of the display is disposed to be eccentric to a center of gravity, a height of the display can be adjusted simultaneously with the rotation of the display to change the arrangement of the display apparatus, thereby satisfying the needs of consumers.

Further, the rotating device can have a slim design due to a simplified structure thereof and may be applied to a small or large display apparatus.

### DESCRIPTION OF DRAWINGS

FIG. 1 is a perspective view of a display apparatus according to an embodiment of the present disclosure.

FIG. 2 is a rear perspective view of the display apparatus according to an embodiment of the present disclosure.

FIG. 3 is an exploded perspective view of a display and a rotating device of the display apparatus according to an embodiment of the present disclosure.

FIG. 4 is a partial perspective view of the rotating device according to an embodiment of the present disclosure.

FIG. 5 is a rear perspective view of the rotating device according to an embodiment of the present disclosure, illustrating a connection portion between a fixed bracket and a torsion spring.

FIG. 6 is a front perspective view of the rotating device according to an embodiment of the present disclosure, illustrating a connection portion between a rotating bracket and the torsion spring.

FIG. 7 is a rear exploded perspective view of the rotating device according to an embodiment of the present disclosure.

FIG. 8 is a front exploded perspective view of the rotating device according to an embodiment of the present disclosure.

FIG. 9 is a view for explaining a combination of a fixing member and a second rotating bracket of the rotating device according to an embodiment of the present disclosure.

FIG. 10 is a cross-sectional view of the rotating device according to an embodiment of the present disclosure, taken along a line A-A′ in FIG. 4.

FIG. 11 illustrates operations in which the display is switched from a first mode to a second mode by the rotating device according to an embodiment of the present disclosure.

FIGS. 12 to 14 illustrate operations of the rotating device when the display according to an embodiment of the present disclosure switches from the first mode to the second mode.

FIG. 15 illustrates operations in which the display is switched from the second mode to the first mode by the rotating device according to an embodiment of the present disclosure.

### MODE OF THE DISCLOSURE

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms. These terms are only used to distinguish one component from another. For example, without departing from the scope of the present disclosure, the first component may be referred to as a second component, and similarly, the second component may also be referred to as a first component. The term “and/or” includes any combination of a plurality of related items or any one of a plurality of related items.

Hereinafter, embodiments of the present disclosure will be described in detail with reference to the accompanying drawings.

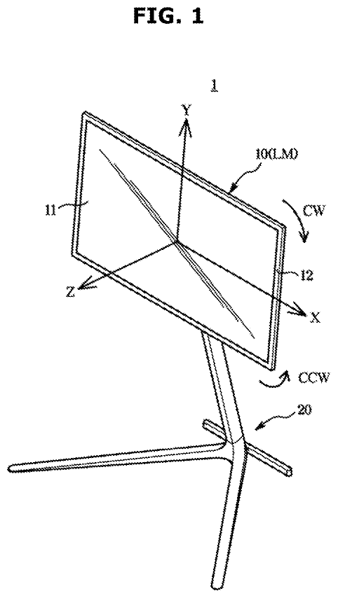

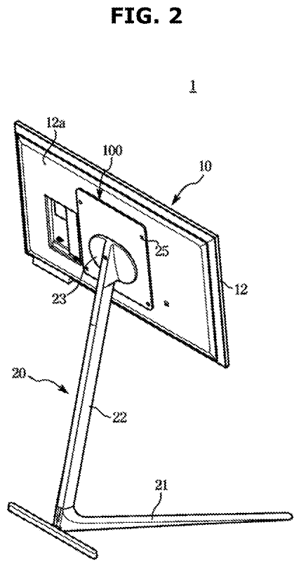

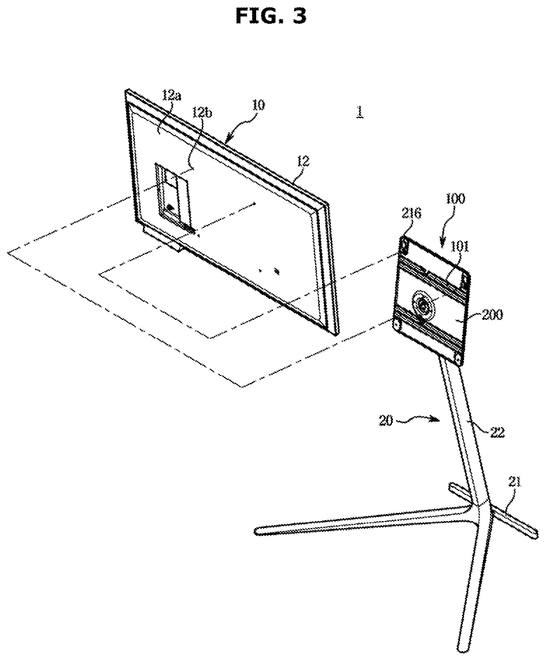

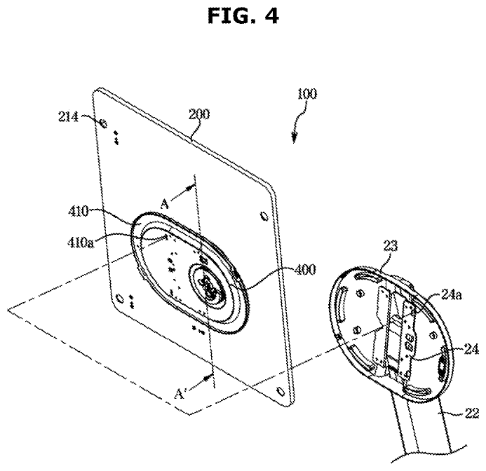

FIG. 1 is a perspective view of a display apparatus according to an embodiment of the present disclosure, FIG. 2 is a rear perspective view of the display apparatus according to an embodiment of the present disclosure, FIG. 3 is an exploded perspective view of a display and a rotating device of the display apparatus according to an embodiment of the present disclosure, and FIG. 4 is a partial perspective view of the rotating device according to an embodiment of the present disclosure.

Although the present disclosure will describe a flat display apparatus as an example, the present disclosure may be implemented in a curved display apparatus having a screen of a fixed curvature and a curvature-variable display apparatus having a screen of a variable curvature as well as the flat display apparatus. In addition, the present disclosure may be applied to a fixed stand, a movable stand, a wall mount, etc., used to support and fix a product (for example, a television, a monitor, and an electronic board), which uses a display, on and to a wall or a floor, and is limited thereto.

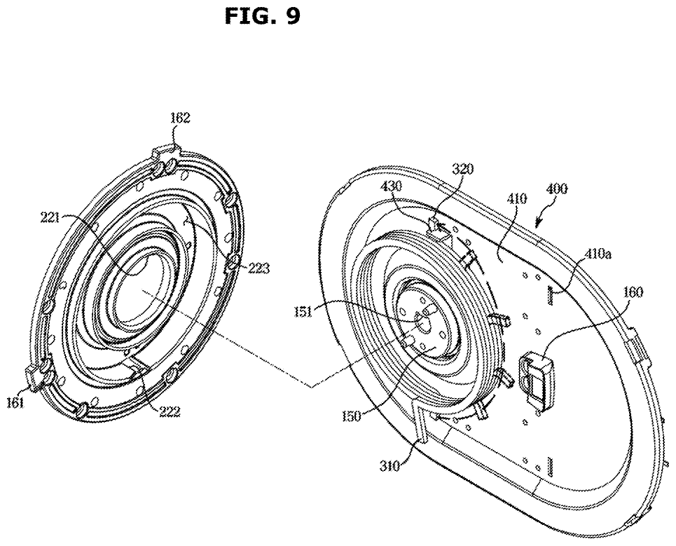

As illustrated in FIGS. 1 to 4, the display apparatus 1 may include a display 10, a support device 20 configured to support the display 10, and a rotating device 100 configured to rotate the display 10 in a horizontal mode (hereinafter, referred to as a first mode LM) in which a horizontal length is longer than a vertical length and a vertical mode (hereinafter, referred to as a second mode PM) in which the vertical length is longer than the horizontal length (see FIG. 9).

Based on the display 10 of the display apparatus 1, an axis in the forward and rearward directions is referred to as a Z axis, an axis in the left and right directions is referred to as an X axis, and an axis in the upward and downward directions is referred to as a Y axis.

When switched from the horizontal mode (first mode LM) to the vertical mode (second mode PM) or from the vertical mode (second mode PM) to the horizontal mode (first mode LM), the display 10 of the display apparatus 1 rotates about the Z axis. The display 10 may rotate in a first direction CW, that is clockwise (CW), and in a second direction CCW, that is opposite to the first direction CW, that is, that is counterclockwise (CCW), about the Y axis.

The display 10 may include a display panel 11, a backlight unit (not shown) to supply light to the display panel 11, and a display chassis 12 forming an exterior.

The display chassis 12 of the display 10 may be provided with at least one rotating device fixing portion 12b to fix the rotating device 100 to a rear surface 12a of the display chassis 12. An embodiment of the present disclosure illustrates that the rotating device fixing portion 12b is a fixing groove formed such that a fastening member such as a bolt 25 may pass therethrough and be coupled to the rotating device 100, but the present disclosure is limited thereto.

The support device 20 is configured to support the display 10 on an installation surface on which the display 10 is installed. The support device 20 may include a stand type support device that is seated on a floor or table, and may include a ceiling type support device that is fixed to a ceiling. Also, the support device 20 may include a wall-mounted support device for mounting a display on a wall. An embodiment of the present disclosure illustrates that the support device is a stand type support device supported on a floor, but the present disclosure is not limited thereto.

The support device 20 may include a base 21 configured to be supported on a floor, a support bar 22 configured to be vertically fixed to the base 21, and a support plate 23 disposed on an upper end of the support bar 22. The support plate 23 includes a fixing plate 24. The fixing plate 24 is configured to be fixed to a fixed bracket 400 of the rotating device 100, which will be described later. The fixing plate 24 is provided with a plurality of fixing protrusions 24a. The fixed bracket 400 may be provided with a plurality of fixing grooves 410a corresponding to the plurality of fixing protrusions 24a.

Accordingly, the fixed bracket 400 of the rotating device 100 to be fixed to the fixing plate 24 is fixed to the support plate 23 of the support device 20, so that the display 10 may rotate relative to the fixed bracket 400 when rotated by the rotating device 100.

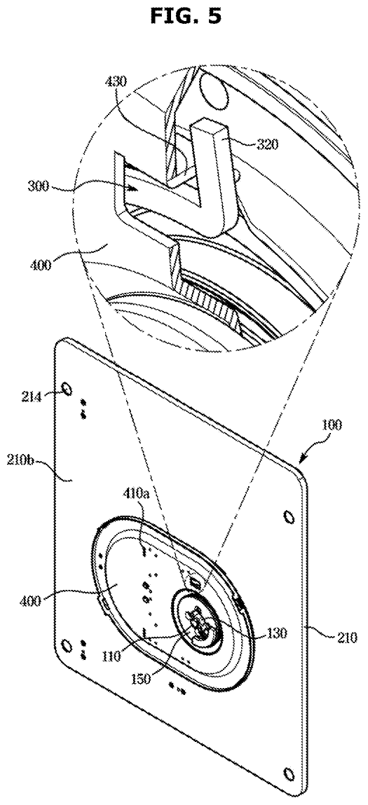

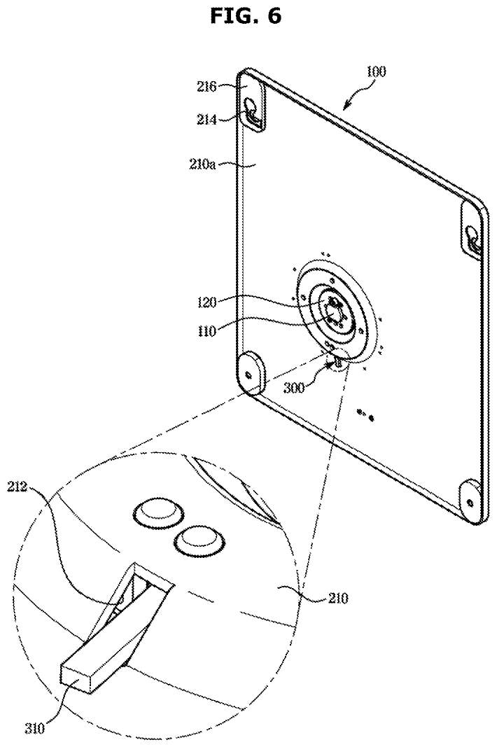

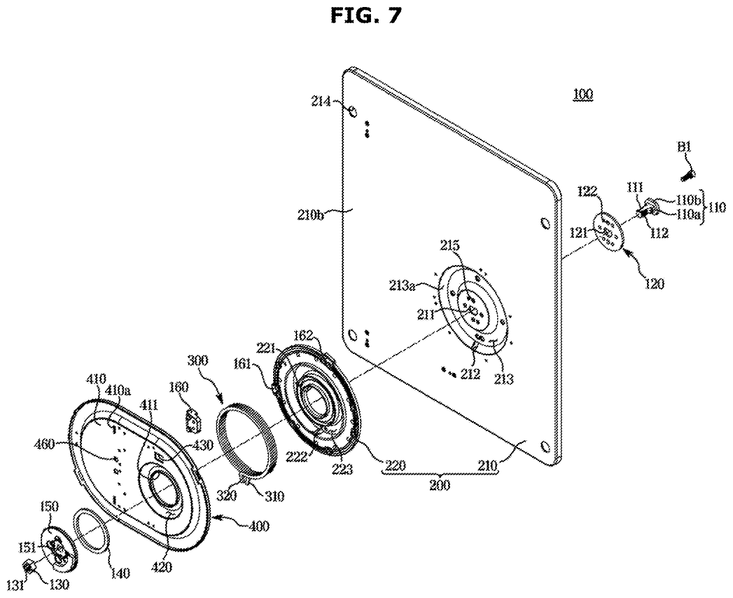

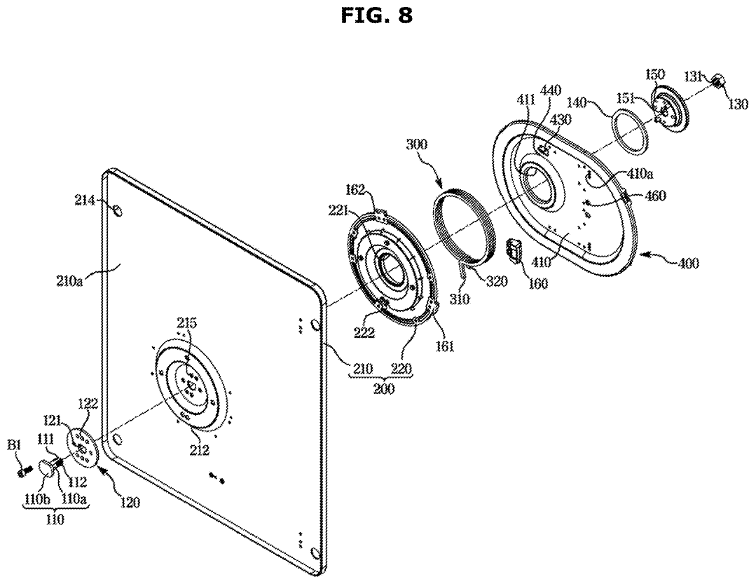

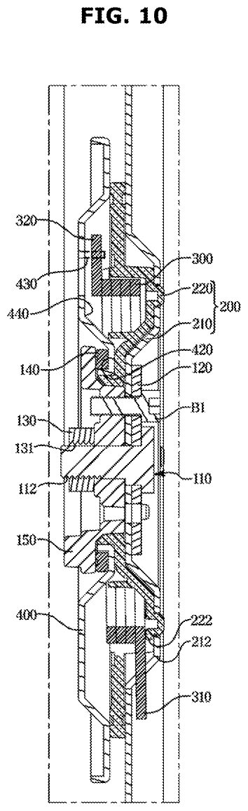

FIG. 5 is a rear perspective view of the rotating device according to an embodiment of the present disclosure, illustrating a connection portion between a fixed bracket and a torsion spring, FIG. 6 is a front perspective view of the rotating device according to an embodiment of the present disclosure, illustrating a connection portion between a rotating bracket and the torsion spring, FIG. 7 is a rear exploded perspective view of the rotating device according to an embodiment of the present disclosure, FIG. 8 is a front exploded perspective view of the rotating device according to an embodiment of the present disclosure, FIG. 9 is a view for explaining a combination of a fixing member and a second rotating bracket of the rotating device according to an embodiment of the present disclosure, and FIG. 10 is a cross-sectional view of the rotating device according to an embodiment of the present disclosure, taken along a line A-A′ in FIG. 4.

As illustrated in FIGS. 5 to 10, the rotating device 100 capable of rotating the display 10 is configured such that the display 10 may be switched between the first mode LM and the second mode PM.

The rotating device 100 may include the fixed bracket 400 and a rotating bracket 200 configured to be able to rotate relative to the fixed bracket 400 and rotate with the display 10.

The rotating bracket 200 may be coupled to the rear surface 12a of the display chassis 12 of the display 10 to rotate together with the display 10. The rotating bracket 200 may be configured to support at least a portion of a rear surface of the display 10.

The rotating bracket 200 may include a reinforcing bracket 101 provided between the rotating bracket 200 and the display 10 to reinforce strength. One or more of the reinforcing brackets 101 may be provided (see FIG. 3).

A display fixing hole 214 corresponding to the rotating device fixing portion 12b of the display 10 may be formed on the rotating bracket 200. The display fixing hole 214 may be formed at a position corresponding to the rotating device fixing portion 12b. The rotating bracket 200 and the display 10 may be fixed by the bolt 25 passing through the display fixing hole 214.

The rotating bracket 200 may further include a display fixing member 216. The display fixing member 216 may be installed at each corner of the rotating bracket 200. The display fixing member 216 may be installed at a position corresponding to the display fixing hole 214. The display fixing member 216 is configured to firmly fix the display 10 to the rotating bracket 200.

The rotating bracket 200 includes a first rotating bracket 210 formed in a substantially rectangular flat plate. The first rotating bracket 210 includes a front surface 210a provided to be in contact with the rear surface of the display 10 and a rear surface 210b provided opposite to the front surface 210a.

A portion of the rotating device 100 may be installed on the rear surface 210b of the first rotating bracket 210. A second rotating bracket accommodating portion 213 formed to be depressed forward may be provided on the rear surface 210b of the first rotating bracket 210.

The rotating device 100 includes a rotation shaft member 110 forming a rotation center of the display 10. The rotation shaft member 110 is coupled to the first rotating bracket 210.

The rotation shaft member 110 is provided in a first rotation shaft passing hole 211 formed on the second rotating bracket accommodating portion 213 of the first rotating bracket 210. The rotation shaft member 110 may pass through and be coupled to the first rotation shaft passing hole 211 formed on the rotating bracket 200. The first rotation shaft passing hole 211 may be formed at a position spaced apart from the center of the first rotating bracket 210. The first rotation shaft passing hole 211 may be formed in the center of the second rotating bracket accommodating portion 213. The first rotation shaft passing hole 211 is formed in a shape corresponding to the rotation shaft member 110. The first rotation shaft passing hole 211 may be formed in a substantially D shape.

The first rotation shaft passing hole 211 may be disposed lower than a center of gravity of the first rotating bracket 210. The rotation shaft member 110 may be disposed higher or lower than a center of gravity C1 of the display 10.

The rotation shaft member 110 is coupled to the first rotation shaft passing hole 211 through the front surface 210a of the first rotating bracket 210. A first friction member 120 may be provided between the first rotating bracket 210 and the rotation shaft member 110. The first friction member 120 is formed in a disk shape. The first friction member 120 is configured to reinforce the strength of the first rotating bracket 210 between the first rotating bracket 210 and the rotation shaft member 110. The first friction member 120 may be configured to generate rotational friction between the first rotating bracket 210 and the rotation shaft member 110. The first friction member 120 may be formed of a metal or plastic material.

The rotation shaft member 110 includes a disk-shaped head portion 110b and a D-shaped rotation shaft body 110a protruding from the head portion 110b. A male thread 122 is formed on the rotation shaft body 110a. At least a portion of the rotation shaft body 110a is formed to be cut. The rotation shaft body 110a formed to be at least partially cut off is provided to prevent loosening with a fixing member 130, which will be described later.

The first friction member 120 is disposed between the head portion 110b of the rotation shaft member 110 and the front surface 210a of the first rotating bracket 210.

A rotation shaft passing hole 121 is formed in the center of the first friction member 120 so that the rotation shaft member 110 passes therethrough. The rotation shaft passing hole 121 is formed in a shape corresponding to the rotation shaft member 110. The rotation shaft member passing hole 121 may be formed in a shape corresponding to the rotation shaft body 110a. The rotation shaft passing hole 121 may be formed in a D shape to correspond to the rotation shaft body 110a.

The first friction member 120 may be provided with a bolt coupling hole 122 in order for the first friction member 120 to be fixed to the first rotating bracket 210. The first friction member 120 is fixed to the rotating bracket 200 by a first bolt B1 coupled to the bolt coupling hole 122. A plurality of the bolt coupling holes 122 may be provided. The plurality of bolt coupling holes 122 may be disposed to be spaced apart from each other on the periphery of the rotation shaft passing hole 121.

A plurality of coupling holes 215 for fixing the first friction member 120 is formed on the first rotating bracket 210, and the plurality of coupling holes 215 and the bolt coupling holes 122 of the first friction member 120 are formed at positions corresponding to each other. The first friction member 120 is fixed to the first rotating bracket 210 through the first bolt B1 passing through the coupling hole 215 and the bolt coupling hole 122.

The second rotating bracket accommodating portion 213 of the first rotating bracket 210 is formed in a circular shape and is formed to be recessed forward. The second rotation bracket accommodating portion 213 includes a ring-shaped inclined surface 213a. A first torsion spring fixing hole 212 for fixing a torsion spring 300, which will be described later, is formed on the inclined surface 213a of the second rotating bracket accommodating portion 213.

The rotating bracket 200 includes a second rotating bracket 220 provided on the second rotating bracket accommodating portion 213 of the first rotating bracket 210. The second rotating bracket 220 may be formed in a circular shape. The second rotating bracket 220 is configured to be fixed to the first rotating bracket 210 to rotate together with the rotation of the first rotating bracket 210.

A torsion spring seating portion 223 for accommodating the torsion spring 300 is formed on the second rotating bracket 220. The second rotating bracket 220 is configured to be fixed to the first rotating bracket 210 to seat the torsion spring 300 and to form rotational friction with the fixed bracket 400. An embodiment of the present disclosure illustrates that the second rotating bracket 220 is provided separately from the first rotating bracket 210, but the present disclosure is not limited thereto. For example, the second rotating bracket may be integrally formed with the first rotating bracket.

A second rotation shaft passing hole 221 is formed in the center of the second rotating bracket 220 so that the rotation shaft member 110 passes therethrough. The second rotation shaft passing hole 221 may be formed at a position corresponding to the first rotation shaft passing hole 211 of the first rotating bracket 210.

The torsion spring seating portion 223 of the second rotating bracket 220 is formed in a ring shape, and a second torsion spring fixing hole 222 for fixing the torsion spring 300 is formed at one side the torsion spring seating portion 223. The second torsion spring fixing hole 222 is formed at a position corresponding to the first torsion spring fixing hole 212.

The fixed bracket 400 is configured to be fixed to the support plate 23 of the support device 20. The fixed bracket 400 is configured such that the rotating bracket 200 is relatively rotatable. The fixed bracket 400 may have a shape corresponding to the support plate 23 and may be formed in a substantially elliptical shape.

The fixed bracket 400 includes a fixed bracket body 410. The plurality of fixing grooves 410a for fixing the support plate 23 is formed on the fixed bracket body 410. A torsion spring installation portion 440 for installing the torsion spring 300 of the rotating device 100 is provided on the fixed bracket body 410.

The torsion spring installation portion 440 is formed on an inner surface of the fixed bracket body 410. The torsion spring installation portion 440 is formed at a position corresponding to the torsion spring seating portion 223 of the second rotating bracket 220. The torsion spring installation portion 440 may be formed to support one side of the torsion spring 300 seated on the torsion spring seating portion 223.

A third rotation shaft passing hole 411 may be formed on the fixed bracket 400 so that the rotation shaft member 110 may pass therethrough. The third rotation shaft passing hole 411 is formed in the center of the torsion spring installation portion 440. The third rotation shaft passing hole 411 is formed at a position corresponding to the first rotation shaft member passing hole 211.

The torsion spring installation portion 440 may be formed in a ring shape and may include a torsion spring fixing portion 430 for fixing the torsion spring 300. The torsion spring fixing portion 430 is formed on the inner surface of the fixed bracket body 410. The torsion spring fixing portion 430 is provided at a position facing the torsion spring fixing holes 212 and 222 formed on the rotating bracket 200. The torsion spring fixing portion 430 may be disposed at an upper side, and the torsion spring fixing holes 212 and 222 may be disposed at a lower side.

The torsion spring fixing portion 430 may be formed on an upper side of the fixed bracket 400. The torsion spring fixing portion 430 may be formed such that at least a portion of the fixed bracket body 410 protrudes in all directions. The torsion spring fixing portion 430 may be formed to protrude from the fixed bracket body 410 toward the rotating bracket 200. The torsion spring 300 supported by the torsion spring fixing portion 430 is configured to apply a rotational force between the fixed bracket 400 and the rotating bracket 200.

The torsion spring 300 is formed in a coil shape and includes a first end 310 formed at one end thereof and a second end 320 formed at the other end thereof. The torsion spring 300 is configured to generate a force by twisting the first end 310 and the second end 320 formed on opposite sides.

The first end 310 of the torsion spring 300 is fixed to the rotating bracket 200. The second end 320 of the torsion spring 300 is supported on and fixed to the fixed bracket 400. That is, the first end 310 of the torsion spring 300 is inserted into and fixed to the first torsion spring fixing hole 212 of the first rotating bracket 210 and the second torsion spring fixing hole 222 of the second rotating bracket 220, and the second end 320 of the torsion spring 300 is supported on and fixed to the torsion spring fixing portion 430 of the fixed bracket 400.

The first end 310 and the second end 320 of the torsion spring 300 are provided to face downward in an initial state. The first end 310 of the torsion spring 300 is inserted into and fixed to the torsion spring fixing hole 212 and 222, and the second end 320 of the torsion spring 300 is provided to be supported on the torsion spring fixing portion 430 in a more wound state than in the initial state. The torsion spring 300 is disposed between the fixed bracket 400 and the rotating bracket 200 and configured to apply a rotational force in a direction opposite to a rotational direction of the rotating bracket 200 when the rotating bracket 200 is rotated.

The fixed bracket 400 further includes a stopper 160 to limit the rotation of the rotating bracket 200.

The stopper 160 may be disposed in a radius of rotation of the second rotating bracket 220 to limit the rotation of the second rotating bracket 220. The second rotating bracket 220 is provided with a first stopper protrusion 161 and a second stopper protrusion 162 provided to be caught on the stopper 160. The first stopper protrusion 161 and the second stopper protrusion 162 may be disposed to be spaced apart from each other by a predetermined distance. The first stopper protrusion 161 is caught on the stopper 160 in the first mode LM, and the second stopper protrusion 162 is caught on the stopper 160 in the second mode PM. The stopper 160 may be disposed between the first stopper protrusion 161 and the second stopper protrusion 162. The first stopper protrusion 161 and the second stopper protrusion 162 are provided on the second rotating bracket 220 to rotate together with the rotation of the display 10. The stopper 160 is provided to limit the rotation of the display 10 to 90 degrees.

A stopper installation portion 460 for installing the stopper 160 may be provided on the fixed bracket 400.

The rotating device 100 includes the fixing member 130 coupled to the rotation shaft member 110 through the third rotation shaft passing hole 411 of the fixed bracket 400. The fixing member 130 may have a female threaded thread 131 therein corresponding to the male threaded thread 122 of the rotation shaft member 110. The fixing member 130 may include a nut. The fixing member 130 is provided to adjust rotational friction between the rotating bracket 200 and the fixed bracket 400. The fixing member 130 is coupled to the rotation shaft member 110 to adjust rotational friction between the rotating bracket 200 and the fixed bracket 400.

The fixing member 130 is fixed to the fixed bracket 400 by a support bracket 150. The support bracket 150 is formed in a disk shape. A fourth rotation shaft passing hole 151 is formed at the center of the support bracket 150 so that the rotation shaft member 110 passes therethrough. The fourth rotation shaft passing hole 151 is formed at a position corresponding to the first rotation shaft passing hole 211. The support bracket 150 is provided between the fixing member 130 and the rotation shaft member 110 to prevent the fixing member 130 from being loosened.

The support bracket 150 may be a friction member for generating rotational friction between the fixed bracket 400 and the fixing member 130.

A second friction member 140 for generating rotational friction between the fixed bracket 400 and the support bracket 150 may be provided between the support bracket 150 and the fixed bracket 400. The second friction member 140 may be formed in a ring shape. The second friction member 140 may be formed of a plastic material. The second friction member 140 may be configured to generate rotational friction between the fixed bracket 400 and the support bracket 150.

A friction member accommodating portion 420 for installing the support bracket 150 and the second friction member 140 may be formed on the fixed bracket body 410 of the fixed bracket 400. The friction member accommodating portion 420 may be formed on the periphery of the third rotation shaft passing hole 411.

Accordingly, a friction force is generated between the rotating bracket 200 and the fixed bracket 400 by the fixing member 130 coupled to the rotation shaft member 110 and the plurality of friction members 120, 220, 140, and 150 disposed between the rotation shaft member 110 and the fixing member 130, and the torsion spring 300 is configured to apply a rotational force between the fixed bracket 400 and the rotating bracket 200 in a direction opposite to the rotation direction of the display 10, so that a smooth rotation operation may be induced.

Hereinafter, the operation of the display apparatus 1 according to the above configuration will be described.

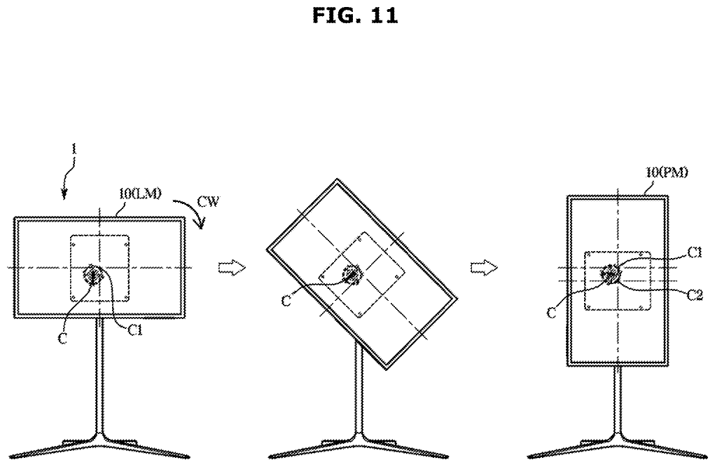

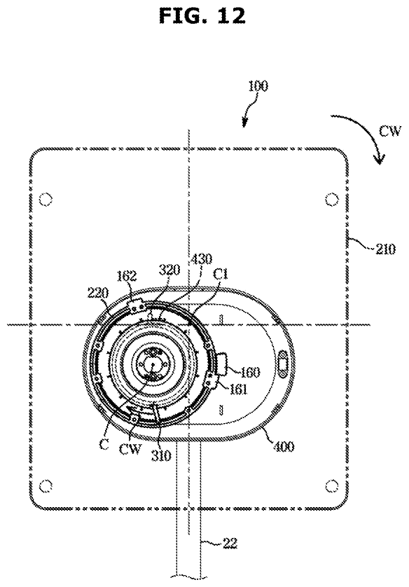

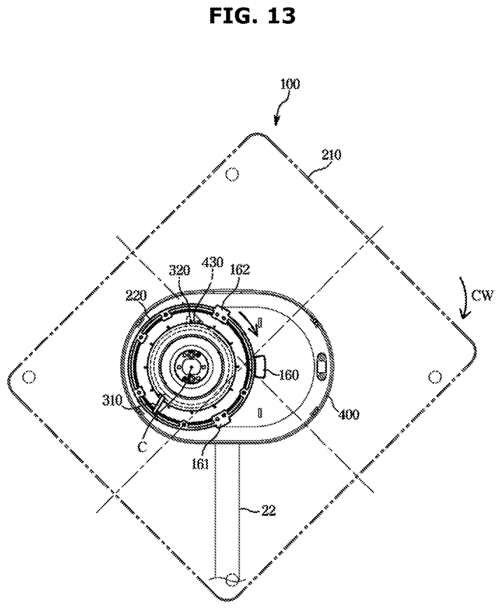

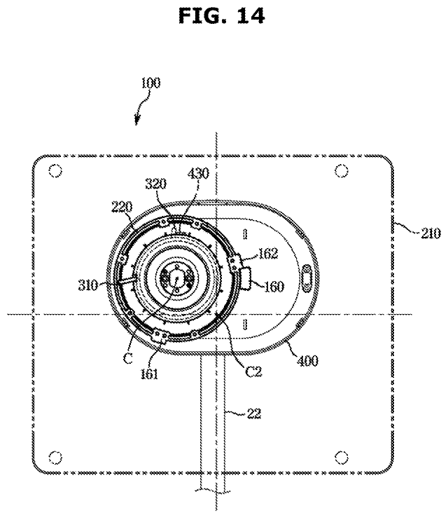

FIG. 11 illustrates operations in which the display is switched from a first mode to a second mode by the rotating device according to an embodiment of the present disclosure, and FIGS. 12 to 14 illustrate operations of the rotating device when the display according to an embodiment of the present disclosure switches from the first mode to the second mode.

As illustrated in FIGS. 11 to 14, when a user applies a force to the display 10 in the first direction CW in a state in which the display 10 of the display apparatus 1 is positioned in the first mode LM (horizontal mode), the display 10 may rotate in the second mode PM (vertical mode).

When the display 10 is positioned in the first mode LM, the rotation shaft member 110 of the rotating device 100 is disposed eccentrically to one side from the center of gravity C1 of the display 10. The rotation shaft member 110 is positioned lower than the center of gravity C1 of the display 10.

When the display 10 is positioned in the first mode LM, the first stopper protrusion 161 of the second rotating bracket 220 is positioned to be supported on the stopper 160.

The user may rotate the display 10 in the first direction CW to switch the display 10 from the first mode LM to the second mode PM.

When the display 10 rotates in the first direction CW, the rotating bracket 200 fixed on the rear surface of the display 10 rotates together with the display 10.

At this time, the rotational force of the torsion spring 300 disposed between the fixed bracket 400 and the rotating bracket 200 applies. One end of the torsion spring 300 is fixed to the fixed bracket 400 and the other end of the torsion spring 300 is fixed to the rotating bracket 200.

The second end 320 of the torsion spring 300 is fixed to and supported on the fixed bracket 400, and the torsion spring 300, whose the first end 310 is fixed to the rotating bracket 200, acts as a damper while being wound.

The torsion spring 300 is configured to prevent the display 10 from rotating rapidly and rotate smoothly.

When the second stopper protrusion 162 of the rotating bracket 200 is caught on the stopper 160 and the rotation thereof is restricted, the display 10 is switched to the second mode PM.

As the display 10 forms an equilibrium state by a frictional force caused by compression of the rotation shaft member 110 and the fixing member 130 of the rotating device 100, the display 10 may be stationary in the second mode PM.

When the display 10 is switched from the first mode LM to the second mode PM, the frictional force between the rotating bracket 200 and the fixed bracket 400 and the rotational force of the torsion spring 300 act in a direction opposite to the first direction CW in which the display 10 rotates, and a force of the user to rotate the display 10 and gravity act in the first direction CW in which the display 10 rotates, so that a smooth rotation operation may be induced.

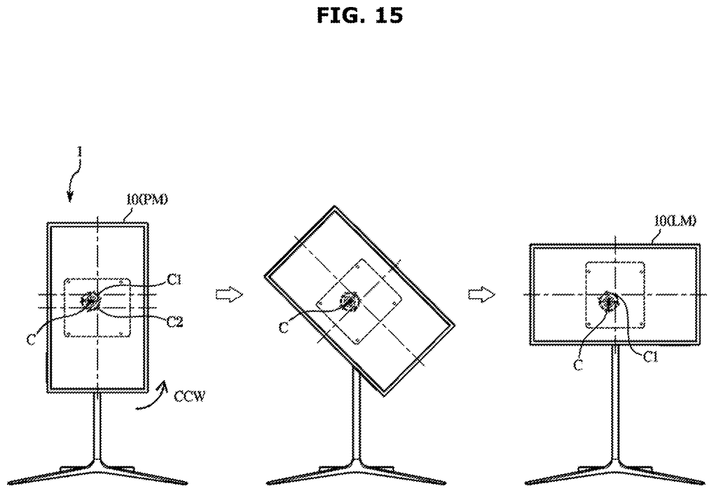

FIG. 15 illustrates operations in which the display is switched from the second mode to the first mode by the rotating device according to an embodiment of the present disclosure.

As illustrated in FIG. 15, when the user applies a force to the display 10 in the second direction CCW opposite to gravity in a state in which the display 10 is positioned in the second mode PM (vertical mode), the display 10 may rotate in the first mode LM (horizontal mode).

When the display 10 is located in the second mode PM, the rotation shaft member 110 of the rotating device 100 is disposed eccentrically to one side from a center of gravity C2 of the display 10. The rotation shaft member 110 is positioned higher than the center of gravity C2 of the display 10.

The center of gravity C1 of the display 10 in the first mode LM is higher than the center of gravity C2 of the display 10 in the second mode PM.

When the display 10 is switched from the first mode LM to the second mode PM or from the second mode PM to the first mode LM, the rotation shaft member 110 may be positioned higher or lower than the centers of gravity C1 and C2 of the display 10.

When the display 10 is positioned in the second mode PM, the second stopper protrusion 162 of the second rotating bracket 220 is positioned to be supported on the stopper 160.

When the user applies a force in the second direction CCW to rotate the display 10 in the second direction CCW so that the display 10 is switched from the second mode PM to the first mode LM, the rotating bracket 200 fixed to the rear surface of the display 10 rotates together with the display 10 in the second direction CCW.

At this time, the torsion spring 300 serves to support the second end 320 fixed to the fixed bracket 400 and add a force in the second direction CCW, that is, the rotation direction, while the first end 310 fixed to the rotating bracket 200 is released.

The torsion spring 300 applies a rotational force so that the display 10 may be rotated even with a small force. The torsion spring 300 is configured to apply a rotational force so that the display 10 may be rotated.

When the rotation of the rotating bracket 200 is restricted by the first stopper protrusion 161 of the rotating bracket 200, which is rotating, being caught on the stopper 160, the display 10 is switched to the first mode LM.

As the display 10 forms an equilibrium state by a frictional force caused by compression of the rotation shaft member 110 and the fixing member 130 of the rotating device 100, the display 10 may be stationary in the first mode LM.

When the display 10 is switched from the second mode PM to the first mode LM, the frictional force between the rotating bracket 200 and the fixed bracket 400 and gravity act in the opposite direction of rotation, that is, the first direction CW, and the rotational force of the torsion spring 300 and a force of the user to rotate the display 10 act in the second direction CCW in which the display 10 rotates, so that a smooth rotation operation may be induced.

An embodiment of the present disclosure illustrates that the center of gravity of the display is lowered when the display is switched from the first mode to the second mode, but the present disclosure is not limited thereto. For example, by setting the position of the rotation shaft member in response to the needs of the user, the display may be configured such that the center of gravity of the display becomes high while the display is switched from the horizontal mode to the vertical mode.

While the present disclosure has been particularly described with reference to exemplary embodiments, it should be understood by those of skilled in the art that various changes in form and details may be made without departing from the spirit and scope of the present disclosure.

1. A display apparatus comprising:
a display on which an image is displayed; and
a rotating device configured to rotate the display,
wherein the rotating device comprises:
a fixed bracket;
a rotating bracket configured to rotate relative to the fixed bracket and rotate the display;
a torsion spring disposed between the fixed bracket and the rotating bracket and configured to apply a rotational force in a second direction opposite to the first direction when the display rotates in a first direction; and
a friction member configured to generate rotational friction when the rotating bracket rotates.

2. The display apparatus according to claim 1, wherein
the rotational force of the torsion spring acts in the second direction when the display rotates in the second direction.

3. The display apparatus according to claim 1, wherein
the rotating bracket comprises a rotation shaft member eccentrically disposed at a center of gravity of the display, and
the rotation shaft member is positioned higher or lower than the center of gravity of the display.

4. The display apparatus according to claim 1, further comprising
a fixing member coupled to the rotation shaft member to adjust rotational friction between the rotating bracket and the fixed bracket.

5. The display apparatus according to claim 4, further comprising
a support bracket configured to support the fixing member from the rear of the fixed bracket.

6. The display apparatus according to claim 5, wherein
the friction member comprises
a first friction member disposed between the rotation shaft member and the rotating bracket, and
a second friction member disposed between the fixed bracket and the fixing member.

7. The display apparatus according to claim 1, wherein
the rotating bracket comprises a first rotating bracket fixed to the display and a second rotating bracket provided on the first rotating bracket and configured to accommodate the torsion spring, and
each of the first rotating bracket and the second rotating bracket comprises a torsion spring fixing hole to fix one end of the torsion spring.

8. The display apparatus according to claim 1, wherein
the fixed bracket comprises a torsion spring fixing portion to fix the other end of the torsion spring.

9. The display apparatus according to claim 1, further comprising
a stopper to restrict the rotation of the rotating bracket.

10. The display apparatus according to claim 2, wherein
the display is configured to be rotatable in a horizontal mode and a vertical mode, and
a center of gravity C1 of the display in the horizontal mode is positioned higher than a center of gravity C2 of the display in the vertical mode.

11. The display apparatus according to claim 10, wherein
a position of the rotation shaft member in the horizontal mode is the same as a position of the rotation shaft member in the vertical mode.
